(19) United States
(12) Patent Application Publication
(10) Pub. No.: US 2017/0248114 A1
(43) Pub. Date: Aug. 31, 2017

(54) A DIFFUSER, USER OF A DIFFUSER AND A WIND TURBINE COMPRISING A DIFFUSER

(71) Applicants: SOREN HJORT, Silkeborg (DK); HELGI LARSEN, Vagur (FO)

(72) Inventors: SOREN HJORT, Silkeborg (DK); HELGI LARSEN, Vagur (FO)

(21) Appl. No.: 15/127,516

(22) PCT Filed: Mar. 30, 2015
(86) PCT No.: PCT/DK2015/050074

§ 371 Date: Sep. 20, 2016

(30) Foreign Application Priority Data
Mar. 31, 2014 (EP) 14162684.6

(51) Int. Cl. F03D 1/04

(52) U.S. Cl. CPC F03D 1/04; F03D 1/06

(57) ABSTRACT

The invention provides for a diffuser (1) for a wind turbine (2). The diffuser (1) comprises an inner diffuser element (8) including a number of vanes (4, 5, 6), wherein at least a first vane (4) and a second vane (5) is arranged in continuation of each other. At least the first vane (4) and the second vane (5) are angled in relation to each other to form a curved cross sectional diffuser profile (7) and a free space (10) is arranged between the neighbouring first vane (4) and second vane (5) to enable air flow between the first vane (4) and second vane (5). The diffuser (1) further comprises at least one further diffuser element (9), wherein at least a first further diffuser element (9) of the at least one further diffuser element (9) is arranged in a further element distance (ED) from the inner diffuser element (8) on an outside (13) of the inner diffuser element (8) in radial direction, so that the further diffuser element (9) substantially encircles the inner diffuser element (8) and so that an open flow-channel (24) is established all the way between the inner diffuser element (8) and the at least one further diffuser element (9), wherein the flow-channel (24) enables air flow all the way through the open flow-channel (24) and out into a wake (25) behind the diffuser (1).

Use of diffuser (1) and a wind turbine (2) comprising a diffuser (1) is also disclosed.

### BACKGROUND OF THE INVENTION

The invention relates to a diffuser for a wind turbine wherein the diffuser comprises a number of vanes. The invention further relates to use of a diffuser and a wind turbine comprising a diffuser.

### DESCRIPTION OF THE RELATED ART

It is known in the art to provide a wind turbine with some form of duct surrounding the rotor to form a so-called Diffuser Augmented Wind Turbine (DAWT) or Shrouded Rotor. Such a diffuser will typically create a low pressure area behind the rotor plan, which will increase the wind speed across the rotor plane. The main advantage of the ducted rotor is that it can operate in a wide range of winds and generate a higher power per unit of rotor area. Another advantage is that the generator operates at a high rotation rate, so it does not necessary require a bulky gearbox, allowing the mechanical portion to be smaller and lighter. A disadvantage is that it is more complicated than the unducted rotor and the duct is usually quite heavy, which puts an added load on the tower. These disadvantages combined with the fact that the output of a wind turbine comprising a traditional diffuser is often at best only comparable to the output of a wind turbine having the same rotor size as the diffuser entails that diffuser wind turbines never have been a real commercial success.

Thus, from EP 0 935 068 A2 it is known to form the diffuser as a number of succeeding, coaxial vanes to increase efficiency in relation to total area. But such a wind turbine with a multi-vane diffuser is still not particularly efficient overall.

From WO 01/06122 A1 it is known to form a diffuser with an aerofoil like cross sectional shape provided with an air inlet at the leading edge and along the outside of the diffuser and a number of outlets distributed along the inside of the aerofoil to reduce the risk of flow separation along the inside of the diffuser. However, the risk flow separation is still too high to make this diffuser design efficient in relation to generating a high output of a wind turbine.

An object of the invention is therefore to provide for an advantageous technique for increasing the output of a wind turbine.

### THE INVENTION

The invention provides for a diffuser for a wind turbine. The diffuser comprises an inner diffuser element including a number of vanes, wherein at least a first vane and a second vane is arranged in continuation of each other. At least the first vane and the second vane are angled in relation to each other to form a curved cross sectional diffuser profile and a free space is arranged between the neighbouring first vane and second vane to enable air flow between the first vane and second vane. The diffuser further comprises at least one further diffuser element, wherein at least a first further diffuser element of the at least one further diffuser element is arranged in a further element distance from the inner diffuser element on an outside of the inner diffuser element in radial direction, so that the further diffuser element substantially encircles the inner diffuser element and so that an open flow-channel is established all the way between the inner diffuser element and the at least one further diffuser element, wherein the flow-channel enables air flow all the way through the open flow-channel and out into the wake behind the diffuser.

The diffuser according to the present invention is a so-called DAWT (Diffuser-Augmented Wind Turbine). A DAWT diffuser is a circular ring-shaped wing with a suction (inner) side and a pressure (outer) side. Centered inside the ring-shaped wing is the wind turbine rotor. Physically, in terms of aerodynamics, the disclosed DAWT diffuser according to the present invention exploits the following techniques to obtain a uniquely high suction zone over the rotor inside the diffuser:
1. Radial sequence of layers: The radially oriented sequence of diffuser elements creates a multi-staged acceleration, where the axial velocity of each of the channel-flows gradually increases. When looking at the flow in these channels at the position of the rotor plane (where the flow augmentation is highest), the augmentation is gradually increasing from the outside in, such that the flow on the pressure side of the outermost diffuser element is slowest, the flow in the outermost channel is faster,—if present—the flow in the next channel even faster, and so on, such that the fastest flow (with the highest power takeout potential) is inside the innermost diffuser element. The cascading effect of successive flow acceleration is created by the channel flows and their outwards deflection caused by the outwards curved layers of diffuser elements.
2. Flap effect: At least the inner diffuser element comprises a number of succeeding ring-shaped vanes which maximizes the extent by which the diffuser element curves outwards without causing flow separation. This is conveniently done by utilizing the flap effect between successive vanes as known from e.g. commercial aircrafts with multiple flaps.

The invention can be conceptually viewed as the DAWT diffuser analogy to a multi-plane aircraft with two or more layers of wings. The ability to position the outer layers such that the overall diffuser radius is not larger than that of the first inner layer makes it possible to obtain power-efficiencies approximately 50 percent higher than present state-of-the-art diffusers for wind turbines.

I.e. if a single diffuser curves too much, the risk of boundary layer separation and subsequent stall and turbulent flow will increase. I.e. there is a physical limitation to how much air a single diffuser of a given size (at a given air speed) can direct away from the rotor to create a partial vacuum behind the rotor. However, by forming the diffuser elements of several vanes arranged in series it is possible to turn the flow more outwards—away from the rotor—without creating flow separation and stall and substantially without increasing the overall size of the diffuser.

By forming a free space between each vane it is possible to create a flow from the pressure side of a first vane (as seen in the flow direction) to the suction side of a subsequent vane and thereby constantly “renew” the boundary layer. Since the boundary layer is constantly renewed it is also possible to turn the airflow more outwards without creating stall and without increasing the overall drag of the diffuser.

And by providing at least one further diffuser element in a distance from the outside of the inner diffuser element and substantially encircling the inner diffuser element it is possible to achieve a cascading effect wherein the air flow on the outside of the inner diffuser element is accelerated so that the speed of the air flow through the free spaces between the vanes of the inner diffuser element is accordingly increased, so that the air speed across the inside of the inner diffuser element can be further increased outwards without risking stall. Thus, by encircling the inner diffuser element with at least one further diffuser element the overall efficiency ratio (i.e. power takeout per area) of the diffuser can be increased.

And by forming an open flow-channel all the way between the inner diffuser element and the at least one further diffuser element the above mentioned cascading effect of successive flow acceleration is enabled. E.g. in the diffuser disclosed in WO 01/06122 A1 no open flow-channel is formed between the pressure side and the suction side of the aerofoil and all the air entering the aerofoil will have to leave the aerofoil through the outlets along the inside of the diffuser. But given the fact that the inside of the aerofoil is a closed space the flow of entering air is substantially stopped before leaving through the outlets whereby the speed of the air flow leaving through the outlets is actually reduced in relation to the inflow speed. Enabling the cascading flow augmentation of the air speed of the open channel flows between radially adjacent diffuser elements of the present invention is considerably increase over the prior art.

In an aspect of the invention, said further element distance substantially decreases in the wind direction as seen during normal use.

Decreasing the distance between the inner diffuser element and the further diffuser element in the wind direction is advantageous in that air will gradually escape the area between the inner diffuser element and the further diffuser element through the gaps between the vanes of the inner diffuser element. To not create a partial vacuum or even to increase the pressure in the wind direction between the inner diffuser element and the further diffuser element it is advantageous that the further element distance substantially decreases in the wind direction.

In an aspect of the invention, said further element distance decreases to a maximum of 30%, preferably 50% and most preferred 80% of the largest further element distance.

If the further element distance decreases too much the viscous wall-effects in the flow-channel will increase and the air flow speed through the flow-channel will decrease—thereby reducing the effect of the diffuser. However, if the further element distance decreases too little the pressure in the flow-channel could increase and thereby reduce the air speed of the supplied through the free space between the vanes of the inner diffuser element—thereby reducing the effect of the diffuser. Thus, the present channel width distance ranges present an advantageous relationship regarding rotor power efficiency.

In an aspect of the invention, a minimum size of said further element distance is between 3% and 90%, preferably between 4% and 60% and most preferred between 5% and 30% of the inner radius of said diffuser.

If the minimum size of the further element distance is too little in relation to the inner radius of diffuser the effect of the diffuser is reduced in relation to the weight and complexity of the diffuser. However, minimum size of the further element distance is too big in relation to the inner radius of diffuser the above mentioned cascading effect is reduced. Thus, the present distance ranges present an advantageous relationship regarding efficiency and weight.

In an aspect of the invention, said further element distance on average is between 0.1 and 20, preferably between 0.2 and 10 and most preferred between 0.5 and 5 times the average chord length of said vanes of said inner diffuser element.

If the inner diffuser element and the further diffuser element are spaced too much apart the effect of the further diffuser element will decrease and if the inner diffuser element and further diffuser element are arranged too close together it will not be possible to create a sufficient air flow. Thus, the present distance ranges present an advantageous relationship regarding efficiency.

In an aspect of the invention, at least one of said at least one further diffuser element also comprises a number of vanes, wherein at least a first vane and a second vane is arranged in continuation of each other, wherein at least said first vane and said second vane are angled in relation to each other to form a curved cross sectional diffuser profile and wherein a free space is arranged between said neighbouring first vane and second vane to enable air flow between said first vane and second vane.

Also forming the further diffuser element as a number of succeeding, coaxial vanes is advantageous in that the further diffuser element more efficiently will increase the speed of the air flowing across the outside of the inner diffuser element thus further increasing the overall efficiency of the diffuser.

In an aspect of the invention, said flow-channel is arranged so that a main part of the air entering said flow-channel at a front end of said flow-channel is leaving said flow-channel at a rear end of said flow-channel directly out into said wake behind said diffuser.

Arranging the flow-channel so that most of the air entering the flow-channel also leaves the flow-channel at the rear end of the flow-channel is advantageous in that this will ensure a high air speed through the flow-channel. And exhausting the air directly out into the wake behind the diffuser is advantageous in that the air speed has been accelerated through the flow-channel and the exhausted air will therefore aid in reducing the pressure behind the rotor and thus increase the efficiency of the diffuser.

In an aspect of the invention, said inner diffuser element is formed as a body of revolution around the centre axis of said diffuser.

Forming the inner diffuser element as a body of revolution—also called axi-symmetric, rotational symmetric or radial symmetric—is advantageous in that any non-symmetry in the circumferential direction will cause vortex creation and subsequent induced drag and reduce efficiency of the diffuser.

In an aspect of the invention, said at least one further diffuser element is formed as a body of revolution around the centre axis of said diffuser.

Forming at least one further diffuser element as a body of revolution is advantageous in that any non-symmetry in the circumferential direction will cause vortex creation and subsequent induced drag and reduce efficiency of the diffuser.

In an aspect of the invention, at least one of said at least one further diffuser element is a diffuser object formed as a body of revolution around the centre axis of said diffuser, wherein the largest cross sectional width of said diffuser object is between 0.1 and 20, preferably between 0.2 and 8 and most preferred between 0.4 and 4 times the largest cross sectional width of said inner diffuser element.

If the largest cross sectional width of the diffuser object is too big in relation to the largest cross sectional width of the inner diffuser element the diffuser object will create too much drag and reduce the overall efficiency of the diffuser and if the largest cross sectional width of the diffuser object is too small it will not be able to increase the air speed across the entire outside surface of the inner diffuser element. Thus, the present size ranges present an advantageous relationship drag and ability to increase air speed.

In an aspect of the invention, said diffuser object is formed as at least a part of a torus.

Forming the diffuser object as at least a part of a torus is advantageous in that it enables a simple and inexpensive design of the further diffuser element.

In an aspect of the invention, said inner diffuser element and/or said at least one further diffuser element comprises at least three vanes arranged in continuation of each other and angled in relation to each other.

Forming the diffuser elements by means of at least three vanes arranged in series is advantageous in that it enables a more curved cross sectional diffuser profile thus enabling more air to be directed away from the wind turbine rotor.

In an aspect of the invention, a cross sectional shape of said first vane and said second vane are formed as at least a part of an airfoil.

Forming the vanes as airfoils is advantageous in that the aerodynamic properties of aerofoils are well-defined in that the aerofoil shape will reduce drag of the diffuser element while at the same time increasing efficiency. Forming the vanes as airfoils is also advantageous in that the lift created by the airfoil design will assist in directing the passing air in the desired direction and thus increase the efficiency of the diffuser.

In an aspect of the invention, a leading edge of said airfoil is arranged to substantially face towards the general wind direction and a trailing edge of said airfoil is arranged to substantially face out of said general direction of the wind during normal use of said diffuser on a wind turbine.

Hereby is achieved an advantageous embodiment of the invention.

It should be noticed that by the term “leading edge” is to be understood the point at the front of an airfoil that has maximum curvature i.e. typically substantially the front of a traditional airfoil moving normally through a medium.

It should be noticed that by the term “trailing edge” is to be understood the point of maximum curvature at the rear of the airfoil i.e. typically point where the suction surface of an airfoil intersects with the pressure surface.

In an aspect of the invention, a trailing edge of said first vane is arranged to substantially overlap a leading edge of said second vane.

Making the trailing edge of the first vane overlap the leading edge of the second vane is advantageous in that the flow across the diffuser element hereby is guided across the entire length of the diffuser element hereby increasing efficiency.

In an aspect of the invention, said first vane is arranged in a vane angle between 0.5° and 85°, preferably between 1° and 50° and most preferred between 2° and 35° in relation to said second vane.

If the vanes are angled too much in relation to each other the risk of stall increases. And if the angle between the vanes is too little the efficiency of the diffuser element is reduced. Thus, the present angle ranges present an advantageous relationship between functionality and efficiency.

In an aspect of the invention, said first vane and said second vane are formed by plate means provided with a cross sectional shape of at least a part of a suction side of an airfoil.

Forming the vanes of plate material or plate-like material is advantageous in that it enables low production cost and a simple manufacturing process. Furthermore, by forming the plate-like material as at least a part of the suction side of an airfoil it is ensured that the vanes will efficiently guide the air flow in the desired direction.

In an aspect of the invention, said diffuser comprises tilting means for tilting at least one vane or at least part of one vane between 10° and 170°, preferably between 30° and 140°.

Providing the diffuser with means for tilting a vane is advantageous in that the tilted vane can block part of the flow area in front of the rotor and thus form at least part of a rotor brake.

In an aspect of the invention, a minimum width of said free space between said neighbouring vanes is between 0.1% and 6%, preferably between 0.3% and 4.5% and most preferred between 0.7% and 3% of the inner radius of said diffuser.

If the minimum width of the free space is too little, too little air will travel from the outside to the inside of a given diffuser element. However, if the minimum width of the free space is too wide it will not be possible to maintain a sufficient air speed towards the rear of the diffuser and the risk of flow separation is therefore increased. Thus, the present distance ranges present an advantageous relationship regarding efficiency.

The invention also provides for use of a diffuser according to any of the previously described diffusers for increasing the air flow through the rotor plane of a wind turbine.

Using a diffuser according to the present invention to increase the air flow through the rotor of a wind turbine is advantageous in that the diffuser according to the present invention will create a larger partial vacuum behind the rotor compared to known diffusers and thus enable larger output from the same wind turbine.

The invention further provides for a wind turbine comprising a diffuser according to any of the previously described diffusers.

Hereby is achieved an advantageous embodiment of the invention.

In an aspect of the invention, at least one vane of said inner diffuser element and/or at least one vane of said at least one further diffuser element is located entirely in front of a rotor plane of said wind turbine.

Arranging at least one vane entirely in front of the rotor plane of the wind turbine is advantageous in that it increases the diffusers efficiency and it enables that this or these vanes can be used as at least part of a rotor brake.

### FIGURES

The invention will be described in the following with reference to the figures in which

FIG. 1 illustrates a large modern wind turbine, as seen from the front,

FIG. 2 illustrates a wind turbine comprising only an inner diffuser element, as seen in perspective,

FIG. 3 illustrates a cross section of a wind turbine rotor comprising a diffuser having two diffuser elements formed by vanes, as seen from the top,

FIG. 4 illustrates a close up of the diffuser cross section shown in FIG. 3, as seen from the top,

FIG. 5 illustrates a wind turbine comprising a four layer diffuser, as seen in perspective,

FIG. 6 illustrates a cross section of a wind turbine rotor comprising a four layer diffuser, as seen from the top,

FIG. 7 illustrates a cross section of a wind turbine rotor comprising two succeeding diffusers, as seen from the top,

FIG. 8 illustrates a cross section of a diffuser having a short inner diffuser element encircled by a torus shaped further diffuser element, as seen from the top,

FIG. 9 illustrates a cross section of a diffuser having two diffuser element layers encircled by a torus shaped further diffuser element, as seen from the top,

FIG. 10 illustrates a cross section of a diffuser having a long inner diffuser element encircled by a torus shaped further diffuser element, as seen from the top,

FIG. 11 illustrates a cross section of a diffuser having a long inner diffuser element encircled by a partly torus shaped further diffuser element, as seen from the top, and

FIG. 12 illustrates a cross section of a wind turbine rotor comprising a diffuser with a tilted vane, as seen from the top.

### DETAILED DESCRIPTION OF THE INVENTION

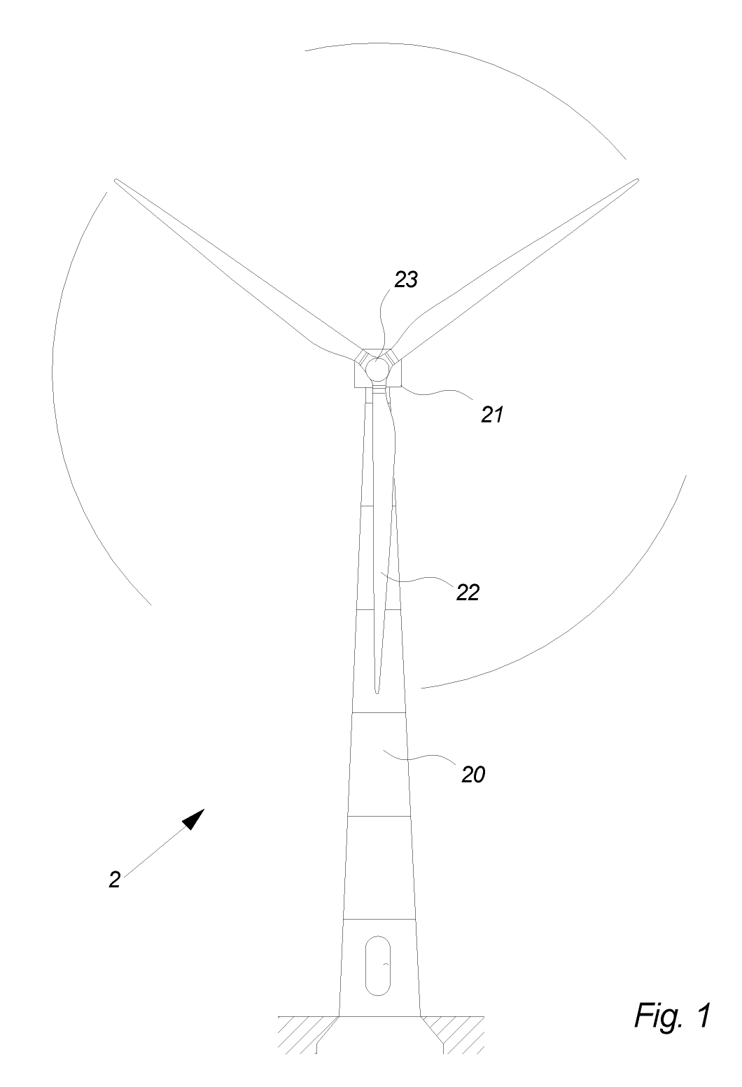

FIG. 1 illustrates a wind turbine 2, comprising a tower 20 and a wind turbine nacelle 21 positioned on top of the tower 20. The wind turbine rotor 19, comprising three wind turbine blades 22 mounted on a hub 23, is connected to the nacelle 21 through the low speed shaft which extends out of the nacelle 21 front.

In another embodiment the wind turbine rotor 19 could comprise another number of blades 22 such as one, two, four or more.

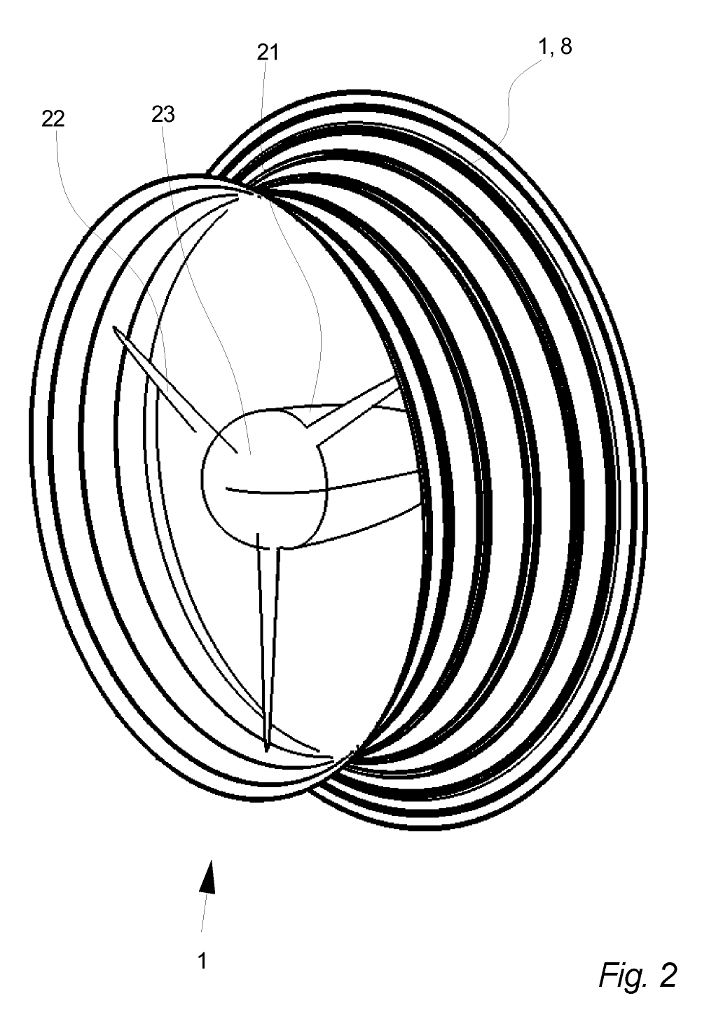

FIG. 2 illustrates a wind turbine 2 comprising only an inner diffuser element 8, as seen in perspective.

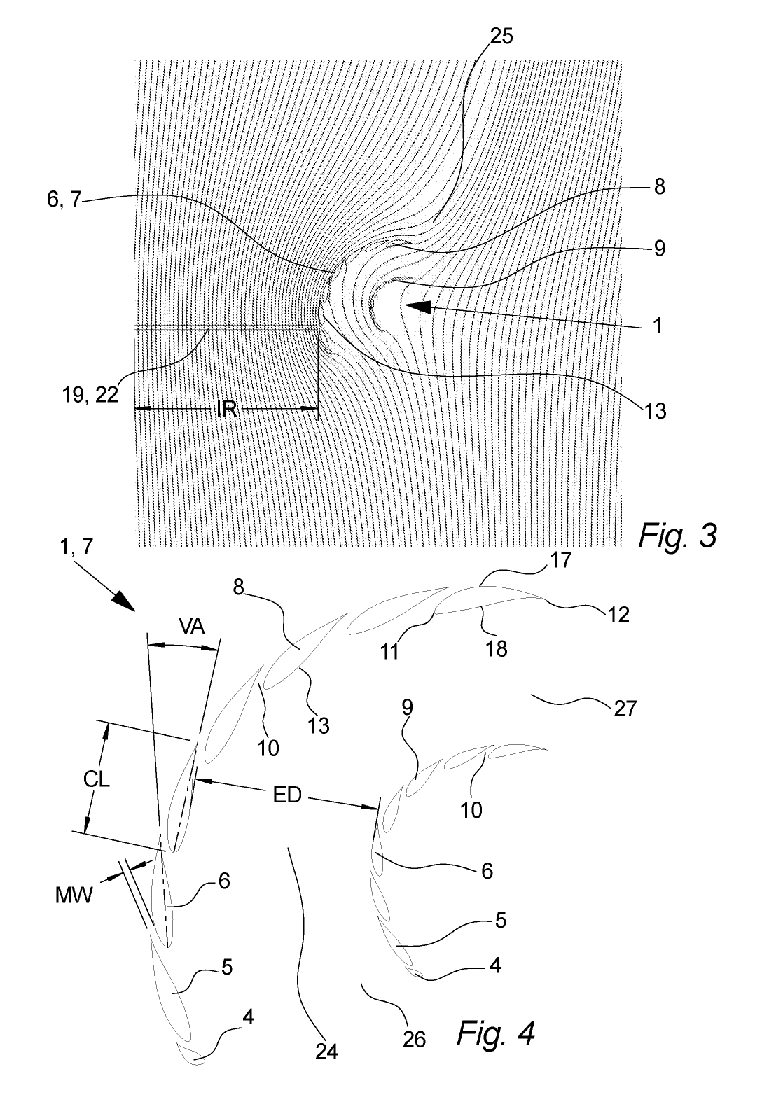

The diffuser 1 disclosed in FIG. 2 is formed by a series of succeeding vanes 4, 5, 6 as disclosed e.g. in FIG. 4 but in this embodiment only the inner diffuser element 8 is disclosed. As disclosed the diffuser 1 typically has the smallest diameter near the front at the rotor plane 19 and then the diameter increases towards the back i.e. in the direction of the wind during normal use. This design entails that the passing air flow is forced outwards—thus creating a partial vacuum behind the rotor 19 as can be seen by the flow lines in FIGS. 3, 6 and 7. Said partial vacuum will increase the air flow through the rotor plane 19 and thus increase the power takeout of the rotor 19.

It should be noted that the wind turbines disclosed in all the figures (except FIGS. 5, 6, 12) are conventional upwind wind turbines i.e. the wind turbines comprises an active yaw mechanism making the rotor face into the wind and ensuring that the rotor substantially always is perpendicular to the direction of the wind. However, as disclosed in FIGS. 5, 6 and 12 in another embodiment the diffuser 1 could just as well be mounted on a downwind wind turbine where the rotor plane is facing out of the wind and the wind turbine is typically not fitted with active yawing means.

FIG. 3 illustrates a rotational symmetric cross section of a wind turbine rotor 19 comprising a diffuser 1 having two diffuser elements 8, 9 formed by vanes 4, 5, 6, as seen from the top and FIG. 4 illustrates a close up of the diffuser 1 shown in FIG. 3, as seen from the top.

In this embodiment both the inner diffuser element 8 and the further diffuser element 9 comprise a first vane 4 followed by a second vane 5 which in turn is followed by six further vanes 6. However in another embodiment any of the diffuser elements 8, 9 could comprise another number of vanes 4, 5, 6 such as two, three, four, five, six, ten, twelve, fifteen or even more e.g. dependent on the specific wind turbine type, the number of parallel arranged diffuser elements 8, 9, the design of the individual vanes 4, 5, 6 or other.

In this embodiment a flow-channel 24 is arranged between the inner diffuser element 8 and the further diffuser element 9 so that most of the air entering the flow-channel 24 at the front end 26 of the flow-channel 24 is leaving the flow-channel 24 again at a rear end 27 of the flow-channel 24 and is therefore exhausted directly out into the wake 25 behind the diffuser 1. I.e. in this embodiment only a minor part of the air entering the flow-channel 24 at the front end 26 of the flow-channel 24 leaves the flow-channel 24 through the free space 10 between the vanes 4, 5, 6 of the inner diffuser element 8.

In this embodiment all the vanes 4, 5, 6 are arranged in continuation of each other, and all the vanes 4, 5, 6 are angled in relation to a preceding vane 4, 5, 6 so that all the vanes 4, 5, 6 together form a curved diffuser profile 7 as seen in the cross sectional view on e.g. FIGS. 3 and 4. The curved cross sectional diffuser profile 7 enables the diffuser 1 to efficiently deflect the passing airflow away from the rotor 19 to generate a partial vacuum behind the rotor plane 19. However, in another embodiment some of the vanes 4, 5, 6 could be spaced further apart so that it could be argued that all the vanes 4, 5, 6 are not arranged in continuation of each other. In another embodiment one or more of the vanes 4, 5, 6 could also be arranged parallel with (i.e. non-angled with) one or more further vanes 4, 5, 6 e.g. to better pass an obstacle or other.

In this embodiment a free space 10 is arranged between neighbouring vanes 4, 5, 6 to enable air flow between the vanes 4, 5, 6. In this embodiment the minimum width MW of the free space 10 between all the vanes 4, 5, 6 of a given diffuser element 8, 9 are substantially uniformly so that the minimum width MW of the free space 10 between the vanes 4, 5, 6 is of substantially uniform size throughout the length of the diffuser element 8, 9. In this embodiment the free space 10 between neighbouring vanes 4, 5, 6 is approximately equal to half the height of the vanes 4, 5, 6 but in another embodiment the gap 10 between the vanes 4, 5, 6 could be smaller or bigger e.g. dependent on the specific vane design, the specific use or other.

In this embodiment the vane angle VA between two neighbouring vanes 4, 5, 6 throughout the entire length of the diffuser elements 8, 9 is approximately 16° but in another embodiment this angle VA could be smaller such as around 14°, 10°, 7° or even smaller or the angle VA could be bigger such as 20°, 25°, 30° or even bigger e.g. dependent on the specific vane design, the specific use or other. And in another embodiment the angle VA between neighbouring vanes 4, 5, 6 could vary throughout the length of the diffuser element 8, 9.

Except for the first vane 4 all the other vanes 5, 6 of a given diffuser element 8, 9 is in this embodiment substantially identical in shape and size. However, in another embodiment the vanes 4, 5, 6 of a given diffuser element 8, 9 could be formed with drastically or slightly different size and/or shape throughout the given diffuser element 8, 9 e.g. dependent on specific use, location of the vanes 4, 5, 6 or other.

Also in this embodiment all the vanes 5, 6 of the inner diffuser element 8 are bigger than all the vanes 4, 5, 6 of the further diffuser element 9. However, in another embodiment all the vanes 4, 5, 6 of all the diffuser elements 8, 9 could be substantially identical in shape and size or all or some of the vanes 4, 5, 6 of some or all the diffuser elements 8, 9 could vary in shape and/or size.

In this embodiment all the vanes 4, 5, 6 are substantially formed as airfoils with a leading edge 11 arranged to substantially face into the general direction of the wind and a trailing edge 12 arranged to substantially face in the opposite direction. However, in another embodiment some or all the vanes 4, 5, 6 could be arranged differently e.g. by making the leading edge 11 of some or all the vanes 4, 5, 6 face directly at the rotor 19 or even away from the general direction of the wind.

Forming the vanes 4, 5, 6 as airfoils entails that each vane (arranged with the leading edge facing into the general direction of normal air flow) comprises a suction surface 17 (a.k.a. in general the surface facing the rotor 19) which is generally associated with higher air velocity and lower static pressure and a pressure surface 18 (a.k.a. in general the surface facing away from the rotor) which has a comparatively higher static pressure than the suction surface 17.

In this embodiment the trailing edge 12 of the first vane 4 is arranged to overlap the leading edge 11 of the second vane 5, the trailing edge 12 of the second vane 5 is arranged to overlap the leading edge 11 of the further vane 6 and so on. However, in another embodiment some or all of the leading edges 11 could be arranged to overlap the trailing edges 12.

Also, in this embodiment the trailing edge 12 of a preceding vane 4, 5, 6 is arranged to overlap the suction surface side 17 of a succeeding vane 4, 5, 6 so that an air flow from the pressure surface side 18 of a preceding vane 4, 5, 6 easily can be channelled to the suction surface side 17 of a succeeding vane 4, 5, 6 through the free space 10 substantially without creating any kind of turbulence—thus, the boundary layer of the vanes 4, 5, 6 is renewed for each vane 4, 5, 6 thus enabling that the curved cross sectional diffuser profile 7 can be formed with a sharper curvature hereby enabling that a diffuser 1 of a given size may direct more air further away from the area behind the rotor 19.

However, in another embodiment the trailing edge 12 of some or all preceding vanes 4, 5, 6 could be arranged to overlap the pressure surface side 18 of a succeeding vane 4, 5, 6.

In this embodiment the chord length CL of a vane 5, 6—except for the first vane 4—is approximately 5.5 times bigger than the maximum height MH of that vane 5, 6 but in another embodiment the chord length CL of a vane 4, 5, 6 could be bigger in relation to the maximum height MH of that vane 4, 5, 6 such as 6.5, 8, 10 times bigger or even bigger or the chord length CL of a vane 4, 5, 6 could be smaller in relation to the maximum height MH of that vane 4, 5, 6 such as only 5, 4, 2 times bigger or even smaller.

It should be noted that in this context the term “rotational symmetric” or “rotational symmetry” should be understood as an object that looks the same after a certain amount of rotation. I.e. in this embodiment the diffuser 1 could be formed a large many-sided polygon substantially having the shape of a circle or the diffuser could be fully axi-symmetric i.e. it could be circular and formed by rotating a shape around the centre axis. The object may have more than one rotational symmetry; for instance, if reflections or turning it over are not counted.

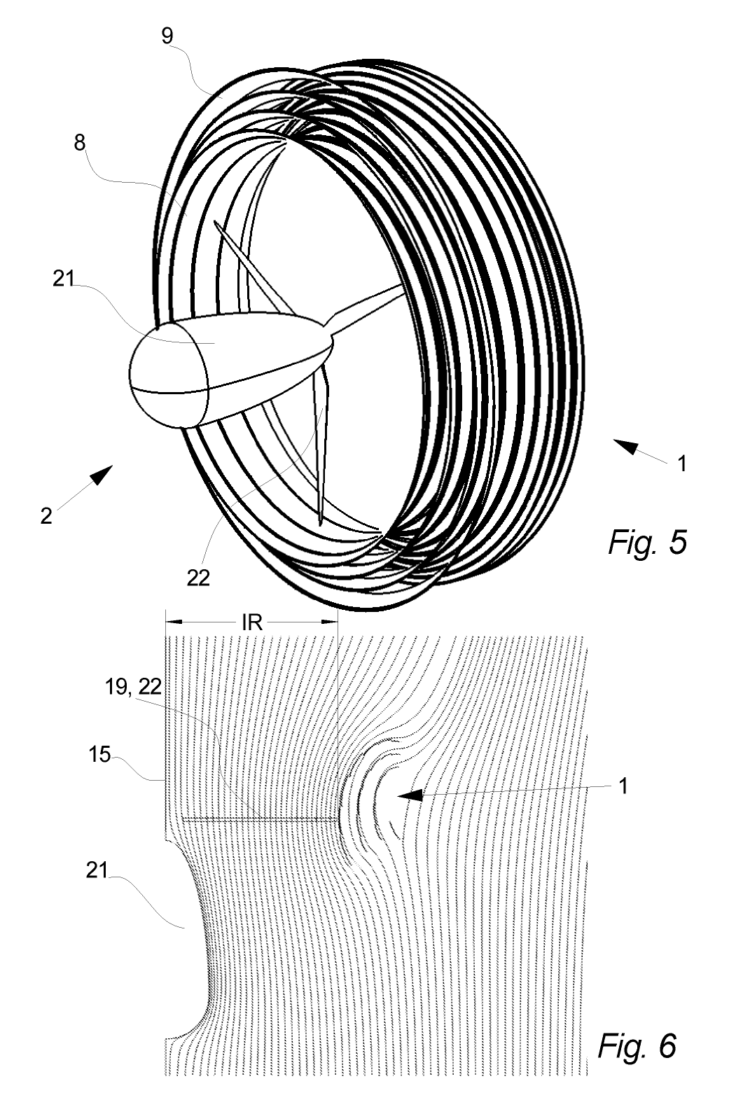

FIG. 5 illustrates a wind turbine 2 comprising a four layer diffuser 1, as seen in perspective and FIG. 6 illustrates a rotational symmetric cross section of a wind turbine rotor 19 comprising a four layer diffuser 1, as seen from the top.

In this embodiment the diffuser 1 comprises four series of vanes 4, 5, 6 forming four curved cross sectional diffuser profiles 7 arranged coaxial in radial succession of each other, but in another embodiment the diffuser 1 could comprise fewer layers of diffuser elements 8, 9 such as one, two or three or more layers of diffuser elements 8, 9 such as five or six e.g. dependent on the specific use, the specific vane design, the specific profile design or other.

The vanes 4, 5, 6 disclosed in FIGS. 3, 4 and 8-11 are all formed as airfoils but in this embodiment the vanes 4, 5 are formed as only part of an airfoil in that each vane 4, 5, 6 of this diffuser 1 are all formed as thin shells substantially resembling the suction side 17 of an airfoil. However, in another embodiment the cross-section of one or more of the vanes 4, 5, 6 in a diffuser 1 could be flat, flat cambered, partly airfoil shaped, fully airfoil shaped or have another geometry e.g. suited to the specific use, the production method, material choice or other.

In this embodiment the vanes 4, 5 are formed by a plate substantially bend into the shape of the suction side 17 of an airfoil. The chord length CL of the vanes 4, 5 formed by a plate-like material is in this case approximately is 70 times bigger than the thickness of the plate but this ratio could be bigger or smaller e.g. dependent on the specific plate material, the production method, the specific use or other.

The embodiments disclosed in FIGS. 2-12 all show diffusers 1 arranged at around the rotor plane of a wind turbine 2 but it is not specifically disclosed how the diffuser 1 is attached to the wind turbine. In the embodiment disclosed in FIG. 5 all the vanes 4, 5, 6 of the inner diffuser element 8 are connected to each other, all the vanes 4, 5, 6 of the succeeding further diffuser element 9 are connected to each other and so on. And in this embodiment the inner diffuser element 8 is connected the wind turbine nacelle 21 by means of three symmetrically arranged brackets (not shown) which extends further outwards to also connect the further diffuser elements 9 to the wind turbine. However it is evident to the skilled person that the vanes 4, 5, 6 can be interconnected or connected to a stationary part of the wind turbine 1 in a multitude of ways that are well known in the art.

In this embodiment and in most embodiments disclosed in the other figures the further element distance ED—i.e. the distance from the outside of a diffuser element 8, 9 to the inside of an encircling diffuser element 8, 9—substantially decreases in the wind direction as seen during normal use. However, in another embodiment the further element distance ED could be substantially constant between two succeeding diffuser elements 8, 9 or the further element distance ED could vary or even increases in the direction of the wind as seen during normal use

In this embodiment the average further element distance ED between the inner diffuser element 8 and the succeeding further diffuser element 9 is approximately the average chord length CL of the vanes 4, 5, 6 of the inner diffuser element 8, the average further element distance ED between the further diffuser element 9 and the next further diffuser element 9 are also spaced apart by approximately the chord length (CL) of the vanes 4, 5, 6 of the further diffuser element 9 and so on. However, in another embodiment two or more of the diffuser elements 8, 9 could be arranged closer together e.g. by 0.2, 0.4 or 0.7 times the average chord length CL of the vanes 4, 5, 6 of the inner diffuser element 8, two or more of the diffuser elements 8, 9 could be arranged further apart e.g. by 2, 3 or 4 times the average chord length CL of the vanes 4, 5, 6 of the inner diffuser element 8 or different diffuser elements 8, 9 could be arranged at different distances to neighbouring diffuser elements 8, 9.

It should be noticed that by the term “chord” is to be understood a straight line connecting the leading edge 11 and trailing edge 12 of the airfoil i.e. the distance between the front and back of the vane 4, 5, 6, measured in the direction of the normal airflow.

For each layer of diffuser elements 8, 9 to be efficient they have to be spaced apart by a substantial distance. Thus, if the diffuser 1 comprises too many layers of diffuser profiles 8, 9—such as more than five layers, more than seven layers or even more layers—the outer layers 9 will have to be arranged so far from the rotor 19 that they become less efficient in relation to the area they cover.

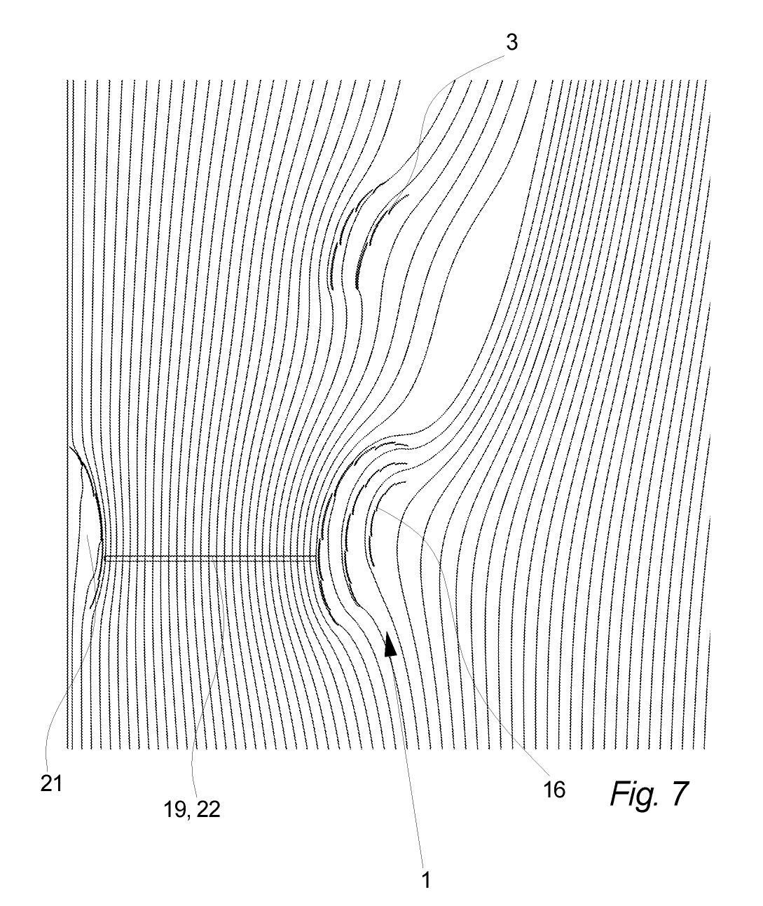

FIG. 7 illustrates a rotational symmetric cross section of a wind turbine rotor 19 comprising two succeeding diffusers 1, as seen from the top.

In this embodiment the diffuser 1 comprises two diffuser parts 24, 25 i.e. a front diffuser part substantially encircling the rotor plane 19 and a diffuser tail 25 arranged behind the rotor plane 19 as seen in the wind direction. As indicated by the air flow lines the diffuser tail 25 will assist in directing more air away from the area behind the rotor 19 and thus create a larger pressure difference over the rotor plane 19.

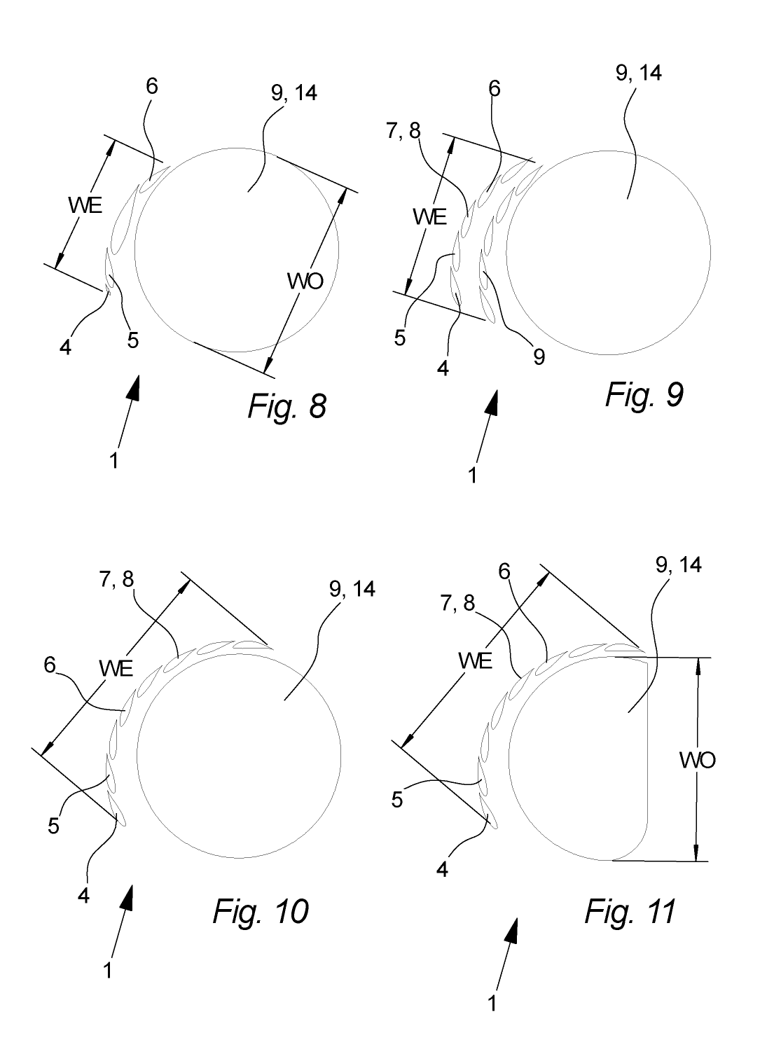

FIG. 8 illustrates a rotational symmetric cross section of a diffuser 1 having a short inner diffuser element 8 encircled by a torus shaped further diffuser element 9, as seen from the top, FIG. 9 illustrates a rotational symmetric cross section of a diffuser 1 having two diffuser element layers 8, 9 encircled by a torus shaped further diffuser element 9, as seen from the top, FIG. 10 illustrates a rotational symmetric cross section of a diffuser 1 having a long inner diffuser element 8 encircled by a torus shaped further diffuser element 9, as seen from the top and FIG. 11 illustrates a rotational symmetric cross section of a diffuser 1 having a long inner diffuser element 8 encircled by a partly torus shaped further diffuser element 9, as seen from the top.

In the embodiments disclosed in FIG. 8-11 the at least one of the further diffuser elements 9 are a diffuser object 14 formed as a large body of revolution around the centre axis 15 of the diffuser 1—which coincides with the rotational axis of the wind turbine rotor 19.

In the embodiments disclosed in FIG. 8-11 the largest cross sectional width WO of the diffuser object 14 is between 0.9 and 1.45 times the largest cross sectional width WE of the inner diffuser element 8 but in another embodiment this ratio could be smaller such as 0.8, 0.6, 0.4 or even smaller or this ratio could be bigger such as 1.6, 1.9, 2.5 or even bigger e.g. dependent on the specific wind turbine type, the specific vane design or other

In FIGS. 8-10 the diffuser object 14 is formed as a complete torus i.e. the further diffuser element 9 is substantially shaped as a donut. However, as illustrated in FIG. 11 the diffuser object 14 is formed as a part of complete torus e.g. to reduce drag or the weight of the diffuser object 14.

In this embodiment the diffuser object 14 is made from sheet aluminium but it is evident to a person skilled in the art that the diffuser object 14 can be made in numerous ways and from many different materials. Although, in most cases it would be essential to ensure that the weight of the diffuser object 14 would be kept at a minimum to reduce strain on e.g. the wind turbine tower 20.

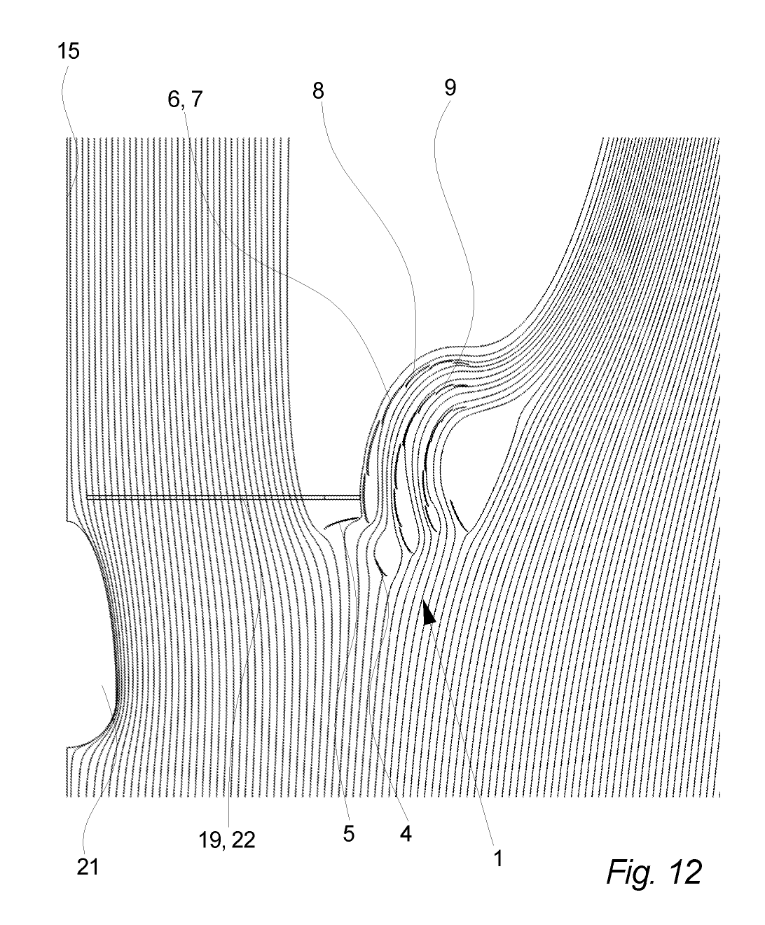

FIG. 12 illustrates a rotational symmetric cross section of a wind turbine rotor 19 comprising a diffuser 1 with a tilted vane 5.

In this embodiment the second vane 5 of the inner diffuser element 8 is provided with tilting means (not shown) enabling that this vane 5 may be tilted from a normal position—e.g. as disclosed in FIG. 6—to a braking position as disclosed in FIG. 12 where the vane 5 will be positioned in the crossflow-direction in front of the rotor 19, such that a non-moving air-volume is created behind it. The part of the rotor 19 rotating in this non-moving air-volume will be impacted by an aerodynamic braking moment causing the spinning rotor 19 to decrease rotational velocity. Thus, in this embodiment the diffuser 1 forms at least part of an aerodynamic brake designed to act on the wind turbine rotor 19.

In this embodiment the diffuser comprises passive tilting means in that the aerodynamic brake is passively activated by the suction pressure created on the vane 5 surface at high wind speed, and will be passively retracted to its original position by spring forces, that will pull back the vane 5 once the high wind speed has decreased. However, in another embodiment the tilting means could comprise active means such as actuators, motors or other.

In this embodiment the tilting means is arranged to tilt at vane 5 approximately 90° but in another embodiment the vane 5 could be tilted more such as 110°, 150° or more or the vane 5 could be tilted less such as 80°, 70° or less.

In this embodiment the diffuser 1 only comprises tilting means, but in another embodiment the tilting means could be supplemented by means for translational movement of the vane 4, 5, 6 also.

In this embodiment only the second vane 5 of the inner diffuser element 8 is turned but in another embodiment other vanes 4, 6 of the inner diffuser element 8 and/or the further diffuser elements 9 could be turned also or instead.

The invention has been exemplified above with reference to specific examples of designs and embodiments of diffusers 1, wind turbines 2, vanes 4, 5, 6, diffuser elements 8, 9 etc. However, it should be understood that the invention is not limited to the particular examples described above but may be designed and altered in a multitude of varieties within the scope of the invention as specified in the claims.

### LIST

1. Diffuser
2. Wind turbine
3. Diffuser tail
4. First vane
5. Second vane
6. Further vane
7. Curved cross sectional diffuser profile
8. Inner diffuser element
9. Further diffuser element
10. Free space
11. Leading edge
12. Trailing edge
13. Outside of the inner diffuser element
14. Diffuser object
15. Centre axis of diffuser
16. Front diffuser part
17. Suction surface
18. Pressure surface
19. Rotor plane
20. Wind turbine tower
21. Nacelle
22. Blade
23. Hub
24. Flow-channel
25. Wake
26. Front end of flow-channel
27. Rear end of flow-channel
ED. Further element distance
VA. Vane angle
CL. Chord length
WO. Largest cross sectional width of diffuser object
WE. Largest cross sectional width of inner diffuser element
IR. Inner radius of diffuser
MW. Minimum width of free space between vanes

1. A diffuser for a wind turbine, said diffuser comprising
an inner diffuser element including a number of vanes, wherein at least a first vane and a second vane is arranged in continuation of each other, wherein at least said first vane and said second vane are angled in relation to each other to form a curved cross sectional diffuser profile and wherein a free space is arranged between said neighbouring first vane and second vane to enable air flow between said first vane and second vane, and
at least one further diffuser element, wherein at least a first further diffuser element of said at least one further diffuser element is arranged in a further element distance (ED) from said inner diffuser element on an outside of said inner diffuser element in radial direction so that said further diffuser element substantially encircles said inner diffuser element and so that an open flow-channel is established all the way between said inner diffuser element and said at least one further diffuser element, wherein said flow-channel enables air flow all the way through said open flow-channel and out into a wake behind said diffuser.

2. A diffuser according to claim 1, wherein said further element distance (ED) substantially decreases in the wind direction as seen during normal use.

3. A diffuser according to claim 2, wherein said further element distance (ED) decreases to a maximum of 30%, preferably 50% and most preferred 80% of the largest further element distance (ED).

4. A diffuser (1) according to claim 1, wherein a minimum size of said further element distance (ED) is between 3% and 90%, preferably between 4% and 60% and most preferred between 5% and 30% of the inner radius (IR) of said diffuser.

5. A diffuser according to claim 1, wherein said further element distance (ED) on average is between 0.1 and 20, preferably between 0.2 and 10 and most preferred between 0.5 and 5 times the average chord length (CL) of said vanes of said inner diffuser element.

6. A diffuser according to claim 1, wherein at least one of said at least one further diffuser element also comprises a number of vanes, wherein at least a first vane and a second vane is arranged in continuation of each other, wherein at least said first vane and said second vane are angled in relation to each other to form a curved cross sectional diffuser profile and wherein a free space is arranged between said neighbouring first vane and second vane to enable air flow between said first vane and second vane.

7. A diffuser according to claim 1, wherein said flow-channel is arranged so that a main part of the air entering said flow-channel at a front end of said flow-channel is leaving said flow-channel at a rear end of said flow-channel directly out into said wake behind said diffuser.

8. A diffuser according to claim 1, wherein said inner diffuser element is formed as a body of revolution around a centre axis of said diffuser.

9. A diffuser according to claim 1, wherein said at least one further diffuser element is formed as a body of revolution around a centre axis of said diffuser.

10. A diffuser according to claim 9, wherein at least one of said at least one further diffuser element is a diffuser object formed as a body of revolution around the centre axis of said diffuser, wherein the largest cross sectional width (WO) of said diffuser object is between 0.1 and 20, preferably between 0.2 and 8 and most preferred between 0.4 and 4 times the largest cross sectional width (WE) of said inner diffuser element.

11. A diffuser according to claim 10, wherein said diffuser object is formed as at least a part of a torus.

12. A diffuser according to claim 1, wherein said inner diffuser element and/or said at least one further diffuser element comprises at least three vanes arranged in continuation of each other and angled in relation to each other.

13. A diffuser according to claim 1, wherein a cross sectional shape of said first vane and said second vane are formed as at least a part of an airfoil and wherein a leading edge of said airfoil is arranged to substantially face towards the general wind direction and a trailing edge of said airfoil is arranged to substantially face out of said general direction of the wind during normal use of said diffuser on a wind turbine.

14. A diffuser according to claim 13, wherein a trailing edge of said first vane is arranged to substantially overlap a leading edge of said second vane.

15. A diffuser according to claim 1, wherein said first vane is arranged in a vane angle (VA) between 0.5° and 85°, preferably between 1° and 50° and most preferred between 2° and 350 in relation to said second vane.

16. A diffuser according to claim 1, wherein said first vane and said second vane are formed by plate means provided with a cross sectional shape of at least a part of a suction side of an airfoil.

17. A diffuser according to claim 1, wherein said diffuser comprises tilting means for tilting at least one vane or at least part of one vane between 10° and 170°, preferably between 30° and 140°.

18. A diffuser according to claim 1, wherein a minimum width (MW) of said free space between said neighbouring vanes is between 0.1% and 6%, preferably between 0.3% and 4.5% and most preferred between 0.7% and 3% of the inner radius (IR) of said diffuser.

19. Use of a diffuser according to claim 1 for increasing the air flow through the rotor plane of a wind turbine.

20. A wind turbine comprising a diffuser according to claim 1.

21. A wind turbine according to claim 20, wherein at least one vane of said inner diffuser element and/or at least one vane of said at least one further diffuser element is located entirely in front of a rotor plane of said wind turbine.
